(19) United States
(12) Patent Application Publication
(10) Pub. No.: US 2017/0255584 A1
(43) Pub. Date: Sep. 7, 2017

(54) MICRO SERVER BASED ON FABRIC NETWORK

(71) Applicant: Electronics and Telecommunications Research Institute, Daejeon (KR)

(72) Inventor: Myeong Hoon OH, Daejeon (KR)

(73) Assignee: Electronics and Telecommunications Research Institute, Daejeon (KR)

(21) Appl. No.: 15/218,472

(22) Filed: Jul. 25, 2016

(30) Foreign Application Priority Data
Mar. 2, 2016 (KR) 10-2016-0025196

(51) Int. Cl. G06F 13/40; G06F 13/42; G06F 13/36; H04L 12/947; H04L 29/06

(52) U.S. Cl. CPC G06F 13/4022; H04L 49/25; H04L 69/16; G06F 13/36; G06F 13/4068; G06F 13/4282; G06F 2213/0026

(57) ABSTRACT

A micro server based on a fabric server is provided. The micro server includes a plurality of computing modules, a first switching module configured to connect the plurality of computing modules through a fabric network based on Ethernet, a plurality of converters respectively connected to the plurality of computing modules, and a second switching module connected to the plurality of converters through a fabric network based on peripheral component interface (PCI) express.

### CROSS-REFERENCE TO RELATED APPLICATION

This application claims priority to and the benefit of Korean Patent Application No. 2016-0025196, filed on Mar. 2, 2016, the disclosure of which is incorporated herein by reference in its entirety.

### BACKGROUND

1. Field of the Invention

The present invention relates to a micro server based on a fabric network, and more particularly, to a micro server based on a high speed fabric network using heterogeneous interfaces.

2. Discussion of Related Art

Cloud computing technology started to emerge in the mid-2000s, and has been established as a core field of information and communications technology (ICT) essential for enhancement of competitiveness of countries and businesses together with the development of a multicore x86 server. However, problems of heat generation and increased power consumption according to the high integration of a processor for a server are serving as obstacles to performance and service quality improvement in a structure of the processor and a design of a data center.

In order to effectively construct a data center based on cloud technology, a method of implementing high integration in a server for a service, a method of using a multicore-based server or highly integrating a large number of processors per unit area in order to construct a large number of servers per unit area, a method of decreasing power consumption of a data center, a method of using a low power processor in order to solve the power consumption and heat generation problems according to the high integration of the processor, etc. should be considered.

In order to construct the data center, it is necessary to develop a subminiature server which is highly integrated, or a low power multicore processor-based server which has low power consumption per unit area and high efficiency.

However, in a case of an x86 architecture-based server, domestic server manufacturing technology relies on an import for every related product, and imported servers are occupying, for the most part, the domestic market due to a lack of attainment of related technology.

Accordingly, it is necessary to develop low power processor-based highly integrated microprocessor server technology of which demand is estimated to be rapidly increased in the future.

In this regard, Korea Patent Application No. 10-2014-0022685 (Title of the Invention: Terminal for Heterogeneous Network Interworking, and Method Using the Same) discloses a terminal for heterogeneous network interworking in which a communication terminal confirms and connects an accessible network by measuring a signal strength of third generation (3G) and fourth generation (4G) networks without performing an operation of registering a position in the 3G network, and a method using the same.

### SUMMARY OF THE INVENTION

The present invention is directed to provide a micro server based on a fabric network capable of automatically selecting networks needed for high speed or low speed data transmission using heterogeneous interfaces.

However, the technical objects which embodiments of the present invention desire to achieve are not limited to the object described above, and there may be other technical objects.

According to an aspect of the present invention, there is provided a micro server based on a fabric network, including: a plurality of computing modules; a first switching module configured to connect the plurality of computing modules through a fabric network based on Ethernet; a plurality of converters respectively connected to the plurality of computing modules; and a second switching module connected to the plurality of converters through a fabric network based on peripheral component interface (PCI) express.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a diagram for describing a fabric network according to an embodiment of the present invention;

FIG. 2 is a block diagram illustrating a micro server according to an embodiment of the present invention;

FIG. 3 is a block diagram of a micro server according to the conventional art;

FIG. 4 is a diagram illustrating an example of mapping a memory region when using a transmission protocol;

FIG. 5 is a flowchart for describing an operation of automatically selecting a network; and

FIG. 6 is a diagram illustrating a differentiated service field of an Internet protocol (IP) header.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention. To clearly describe the present invention, parts irrelevant to the description will be omitted from the drawings.

The term “include,” when used herein, does not preclude the presence or addition of one or more components, steps, operations, and/or elements other than stated components, steps, operations, and/or elements.

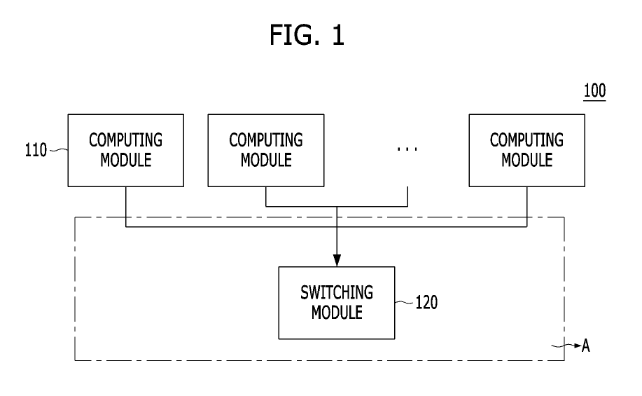

FIG. 1 is a diagram for describing a fabric network according to an embodiment of the present invention.

A highly integrated micro server 100 according to an embodiment of the present invention may include a plurality of computing modules 110. In this case, the plurality of computing modules 110 may be connected to a switching module 120, and perform communication through a fabric network A.

In this case, the micro server 100 according to an embodiment of the present invention may transceive data using a peripheral component interconnect (PCI) express-based network as well as an Ethernet network. Hereinafter, the PCI express and Ethernet applied to the micro server 100 according to an embodiment of the present invention will be briefly described.

According to Moore's law, as performance and a degree of integration of the processor are driven to be increased much more, a necessity for a more high speed interconnect (hereinafter, it may be referred to as a network) is continuously increased. Accordingly, a network currently supports a speed of 1 to 40 gigabits per second, which is expected to be expanded to a speed of hundreds of gigabits per second in the future.

Compared to the increase of the speed of the network, the discussion regarding the type of supported transaction, communication latency, communication overhead, and what kind of topology is easily supported is lacking.

Generally, networks may be generated in the same manner. Although such networks may be known to have an advantage based on simply peak bandwidth, it may be different in the real world.

That is, as there are various processors optimized for general purposes, signal processing, a graphic application, a communication application, etc. are present, networks should also be designed to be optimized in order to solve various connectivity problems.

Meanwhile, the processor used in a computing module 110 of the micro server 100 may provide the peripheral component interconnect (PCI) express Gen2 or Gen3 and a standard interface based on the 10 Gbit Ethernet.

Each technology evolved into a multi-lane serializer/deserializer (SerDes) physical layer, and use 8B/10B line coding or more effective line coding like 64B/66B line coding in order to support a high speed. Although the PCI express supports a much wider interface which is four lanes or more, it is not used since the much wider interface is not suitable for backplane, fiber or cable connection.

The PCI express was designed for connecting traditional slave devices, that is, Ethernet, a network interface card, or a graphic chip, to a host processor. The PCI express was not designed for the connection between processors, and was designed as a serialized version of a PCI bus.

The PCI express supports a bus structure having a single root complex in terms of the topology, and a PCI express switch has a root complex in an upward direction and an attached device in a downward direction. Basically, the switch was designed for expanding the connectivity of peripheral devices in a system.

The PCI express does not support peer-to-peer connection between processors. When using the PCI express in order to connect processors, complexity may be greatly increased. When constructing a multiprocessor network from the PCI, a new mechanism for overcoming a basic specification of the PCI and mapping a device identifier and an address space between multiple hosts or root processors may be required.

The PCI express is not a routable protocol like Ethernet. Further, the PCI express defines a large one address space to which devices are mapped. A load, or store operation accessing an address region related to a specific device is the most common communication method through the PCI express.

A PCI express bridge or switch may compare a set having base and limit values in a packet with a 32-bit or 64-bit address, and transmit the packet to a downstream switch corresponding to an address included in the packet, or a device corresponding to an address.

The PCI express was evolved to support non-transparent bridging (NTB), and this means that a plurality of root complexes may transmit a transaction to each other. Generally, the NTB may require an address of the packet and bus/device/function number to be converted in order to solve a collision problem between global address maps of root complexes different from each other. However, a standard for implementing the conversion function in actual situations is absent.

Without improving capabilities of a Base PCI express protocol, a method for a peer-to-peer processor connection does not exist. Likewise, an ability to connect the switch or an ability to support a topology such a mesh or fat-tree may become problematic. Further, there may be a problem of interoperability between different vendor products.

On the contrary, the PCI express was designed to be tightly integrated with a memory subsystem in a system on chip (SoC) device. This may dramatically reduce latency, and increase a bandwidth. An external fabric interface such as Infiniband or Ethernet requires an additional communication operation in order to move data from a processor memory or to a processor memory.

That is, in a system including a single host device and another processor operating as a slave device, and accelerators, the PCI express may be suitable for the network. However, in a more complex system, the PCI express has a limitation in terms of supporting peer-to-peer connection, and the topology when connecting a plurality of processors.

Meanwhile, in a data center environment, Ethernet is ubiquitous, and an Ethernet switch was evolved to support various virtual local area networks (LANs) which can be routed using a much more simple indexing method. Accordingly, in the data center, Ethernet may be useful for communication between computers, but unnecessary power, costs, complexity may be increased when internal point-to-point communication in an embedded computer, that is, Ethernet as a fabric solution is used.

Ethernet and a transmission control protocol (TCP)/Internet protocol (IP) supporting Ethernet are designed to suitable for a lossy and dynamic environment. They may be suitable for connecting distributed heterogeneous computers.

However, when the computers are hosted and virtualized in processor arrays which are closely connected, an overhead may be generated since Ethernet has a lossy connection with a software-based communication protocol.

Further, one-way communication of Ethernet based on the switch using the TCP/IP may generally require tens of microseconds. A traditional multicore processor may perform hundreds millions of operations during a time taken for transceiving a communication message in one processor. For example, when a clock speed is 10 MHz, a clock period is 100 ns, that is, a time taken for transceiving a message is about 100 ns.

The Ethernet protocol does not support an automatic packet acknowledgement, meaning that the target of an Ethernet packet does not automatically communicate back to the sender the receipt of the packet or the results of the request. By leaving the packet reliability confirmation to software, Ethernet may have significant latency in a low level transaction compared to the PCI express.

For example, when Ethernet is used for performing something like a remote memory read operation, a very common remote direct memory access (RDMA) read operation, Ethernet network interface card hardware receives the packet including the read request, and software interprets the packet. Further, the packet is classified as a specific type, and when being confirmed as an RDMA read operation, a request message is transmitted to the RDMA software. The RDMA software interprets the request, confirms the requested data, and prepares the Ethernet packet.

A response packet may transmit the requested data to a requestor through the TCP/IP, Ethernet stack, and driver software. On the contrary, a read operation of data in the PCI express may be performed in the hardware without interaction of the software, and generally, transaction latency may be 1 us to 500 ns. This may be a time which is much shorter than a time taken when accessing an on-chip resource or a dynamic random access memory (DRAM).

Meanwhile, the Ethernet value proposition is very well known, but important matters may exist for transmission for the connection between the processors in the system which is tightly coupled. Of course, it may obviously be a good selection for connecting servers or computers, as networking requirements are increased by a software-defined network (SDN) requirement, routers should be accessed and many more operations should be performed in terms of the complexity in order to apply past Ethernet switch products.

The SDN switches may perform a switching decision based on much deeper packet information including an IP address, TCP port number, and potentially even based on related application data that the packet is targeted at. Ethernet MAC processing (often with acceleration), and Ethernet or SDN switching latency together with all software transaction processing may add complexity, costs, and power consumption in the system.

The micro server 100 according to an embodiment of the present invention may transceive data using a fabric network based on Ethernet, and a network based on the PCI express, as the networks.

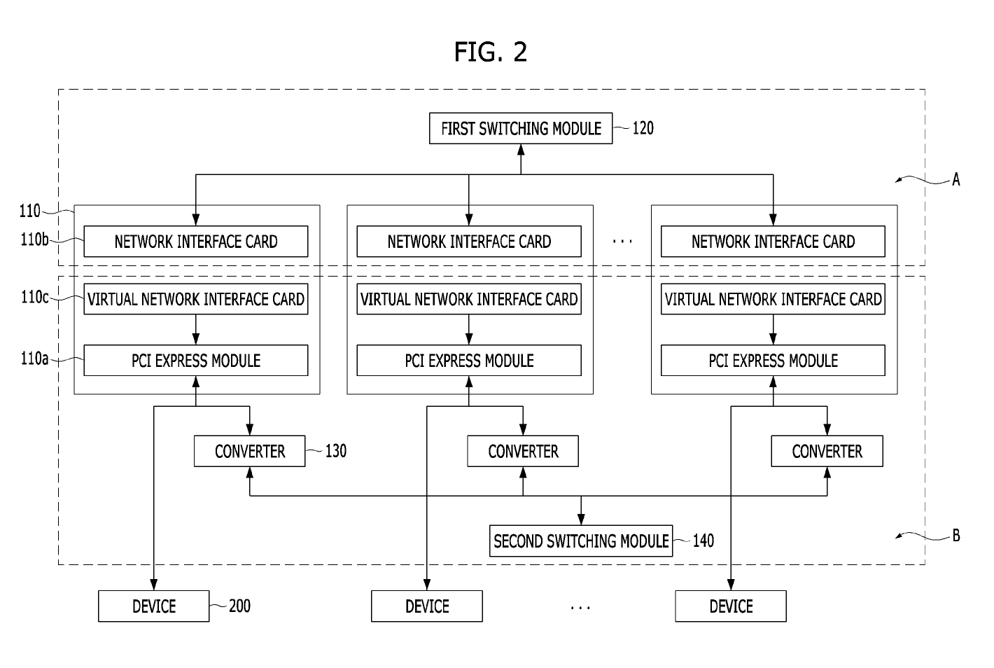

Hereinafter, the micro server 100 according to an embodiment of the present invention will be described in more detail with reference to FIGS. 2 to 6.

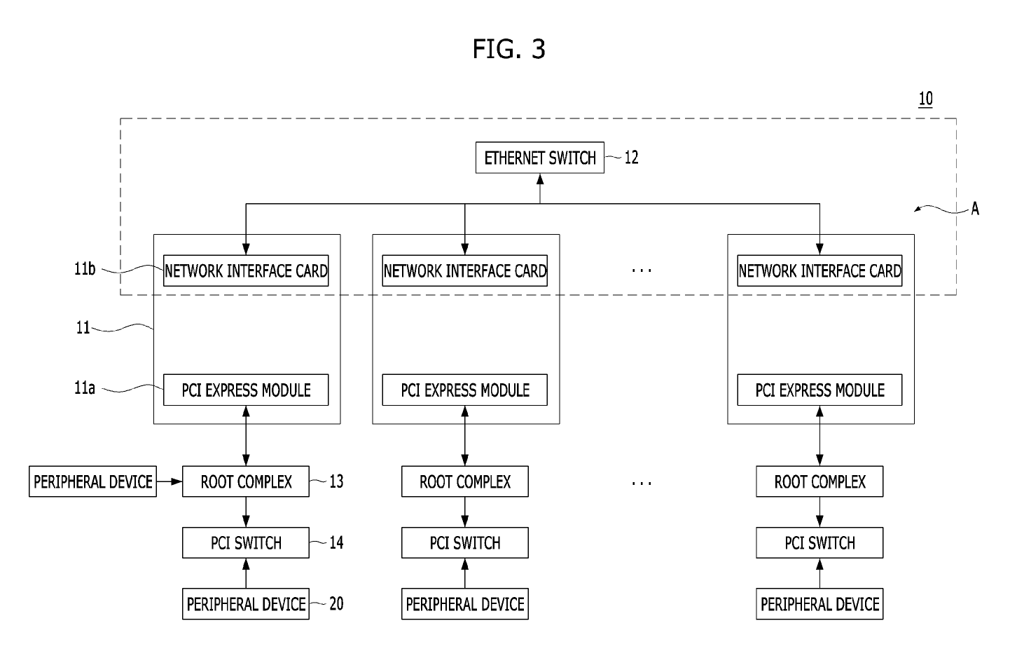

FIG. 2 is a block diagram illustrating the micro server 100 according to an embodiment of the present invention. FIG. 3 is a block diagram illustrating a micro server 10 according to the conventional art.

First, referring to FIG. 2, the micro server 100 based on the fabric network according to an embodiment of the present invention may include a plurality of computing modules 110, a first switching module 120, a plurality of converters 130, and a second switching module 140.

The first switching module 120 may connect the plurality of computing modules 110 through a fabric network A based on Ethernet.

The plurality of converters 130 are respectively connected to the plurality of computing modules 110.

The second switching module 140 connects the plurality of converters 130 by forming a network B based on the PCI express.

Meanwhile, referring to FIG. 3, the micro server 10 according to the conventional art uses an Ethernet switch 12 as the fabric network, and a PCI express module 11a is connected to a root complex 13 and a PCI express switch 14, and used as a device network which can access peripheral devices 20 of each computing module 11.

However, when the micro server 10 is expanded from the form of a simple web server to the form of a server which can process large amounts of data at high speed, which is called big data, the communication performed in the micro server 10, and a data transmission speed or a bandwidth required according to content may be diverse.

In addition, when not only supporting a specific service continuously but also supporting various services dynamically due to a characteristic of a data center to which the micro server 10 is applied, contents processed by the micro server 100 may also be dynamically changed in terms of efficient use of resources.

In this case, since an operation of processing data using the fabric network A based on the single Ethernet of the conventional art relatively has a large latency characteristic compared to the network based on the PCI express, there may be a problem in which the kind of a service capable of being processed is limited.

However, the micro server 100 according to an embodiment of the present invention may use the network B based on the PCI express and the fabric network A based on Ethernet using in a general-purpose processor, and provide a structure capable of processing various services.

In more detail, the micro server 100 according to an embodiment of the present invention may perform data transmission between the plurality of computing modules 110 using the first switching module 120 through a network interface card 110b. That is, the Ethernet network A may be used when the computing modules 110 transmit low speed data to each other.

Each of the plurality of computing modules 110 may include the PCI express module 110a. In this case, the PCI express module 110a may transceive data with the device 200 based on the PCI express.

In this case, the plurality of computing modules 110 may transceive data with the device 200 through a transmission protocol. That is, the PCI express module 110a may maintain and use the network B based on the PCI express of the conventional art as is in order to access the peripheral device 200. Accordingly, the micro server 100 according to an embodiment of the present invention may transmit data through the network B based on the PCI express which is more effective in terms of latency when transmitting high speed data.

In this case, the transmission protocol according to an embodiment of the present invention is not limited to a specific transmission protocol, and various protocols may be applied.

The converter 130 converts data between the PCI express module 110a and the transmission protocol.

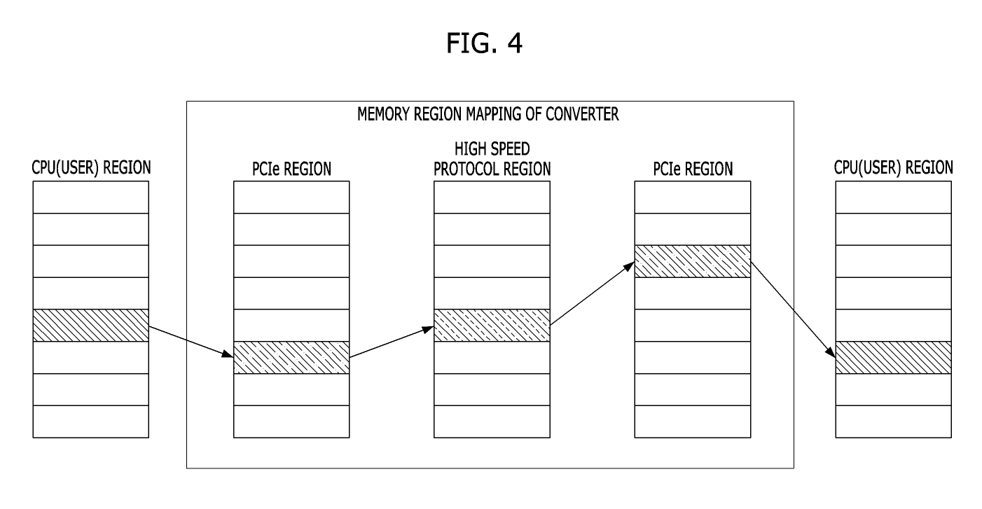

FIG. 4 is a diagram illustrating an example of mapping a memory region when using a transmission protocol.

As shown in FIG. 4, the converter 130 according to an embodiment of the present invention may perform mapping between memory regions for transmitting data between the PCI express module 110a and the transmission protocol.

In this case, the converter 130 may convert the PCI express packet into a high speed protocol packet when transmitting data, and convert the high speed protocol packet into the PCI express packet when receiving data.

The PCI express module 110a may perform the mapping between a memory region of a central processing unit (CPU) and a memory region of the PCI express module.

Meanwhile, in a LAN environment, when transmitting not the Ethernet protocol but other standard data transmission protocols such as voice, video, a universal serial bus (USB), etc., there may be a case in which Ethernet which is widely being used and has high expandability is used. For example, technologies such as voice over IP, USB over IP, high definition multimedia interface (HDMI) over IP, etc. may transmit a protocol for exclusively using a specific application through a network based on Ethernet.

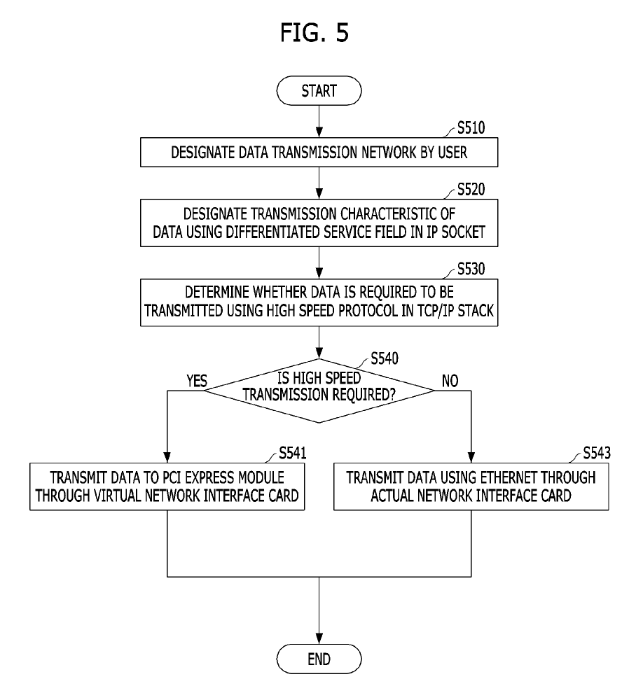

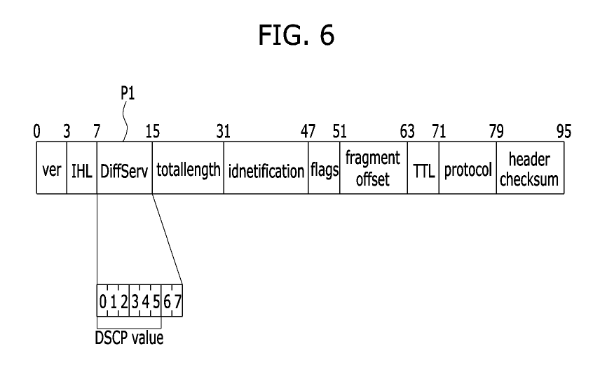

Similar to an embodiment of the present invention, it may be possible to transmit high speed and low speed data through the fabric network B in the micro server 100. That is, it may be possible to transmit the high speed protocol through the PCI express module 110a using the Ethernet protocol. This will be described with reference to FIGS. 5 and 6.

FIG. 5 is a flowchart for describing an operation of automatically selecting a network. FIG. 6 is a diagram illustrating a differentiated service field of an IP header.

The micro server 100 according to an embodiment of the present invention may transmit data to the PCI express module 110a, not through an actual network interface case 110b but rather through a virtual network interface card 110c, when the data is required to be transmitted in high speed.

In this case, when executing an application program and transmitting data, a user may predetermine in advance whether to transmit data using the high speed protocol or a general Ethernet.

Accordingly, in a case in which the generated data is required to be transmitted at high speed when transmitting data, the data may directly be transmitted to the PCI express module 110a through the virtual network interface card 110c, and on the other hand, may be transmitted to the Ethernet network A through the actual network interface card 110b.

In this case, in an embodiment of the present invention, a transmission path of data may be automatically determined rather than the data may not be directly input by the user.

Referring to FIG. 5, whether to use a high speed protocol or a general Ethernet is predesignated by the user (S510), a transmission characteristic of the data may be designated using a differentiated service field in an IP socket (S520).

After this, whether the data is required to be transmitted using the high speed protocol may be determined by determining the differentiated service field in the TCP/IP stack (S530).

Accordingly, when it is determined that the data is required to be transmitted using the high speed protocol (S540), the data may be transmitted to the PCI express module 110a through the virtual network interface card 110c (S541), and on the other hand, the data may be transmitted using the general Ethernet through the actual network interface card 110b (S543).

Meanwhile, as described above, the operations S510 to S543 may be separated into additional operations, or be combined into fewer operations. Further, some operations may be omitted according to necessity, and the order of the operations may be changed. Moreover, although omitted, the description regarding the micro server of FIGS. 1 to 4 which was described above may be also applied to the method of selecting a network.

Referring to FIG. 6, an IP header packet may include the differentiated service field P1. Accordingly, in an embodiment of the present invention, information regarding whether the data requires high speed transmission may be predesignated in the differentiated service field P1, and may be determined in the TCP/IP stack.

As shown in FIG. 2, in the fabric networks A and B having heterogeneous interfaces, the micro server 100 according to an embodiment of the present invention may transmit low speed data based on the Ethernet network A, and when desiring to transmit data at high speed, transmit the data through the virtual network interface card 110c using the PCI express module 110a.

For reference, components shown in FIGS. 1 to 3 according to an embodiment of the present invention may be implemented by software or hardware such as a field programmable gate array (FPGA) or an application specific integrated circuit (ASIC), and perform predetermined functions.

However, the term “components” is not limited to software or hardware, and each component may be configured to include a storage medium which is addressable, and configured to operate one or more processors.

Accordingly, as an example, the component may include components such as software components, object-oriented software components, class components, and task components, processors, functions, attributes, procedures, subroutines, segments of program code, drivers, firmware, a microcode, a circuit, data, a database, a memory, data structures, tables, arrays, and variables.

The components and functions provided in the components may be combined into fewer components, or further separated into additional components. According to an embodiment of the present invention described above, the network for transmitting high speed or low speed data may be automatically selected using the heterogeneous interfaces.

Further, a highly integrated subminiature server may be provided, and also, power consumption may be decreased.

Each operation performed by the micro server according to an embodiment of the present invention may be implemented in a form of a recording medium including a computer program stored in a computer executable medium or computer executable commands. The computer readable medium may be an arbitrary available medium which is able to be accessed by a computer, and may include a volatile or non-volatile medium, and a separable or nonseparable medium. Further, the computer readable medium may include a computer storage medium and a communication medium. The computer storage medium may include the volatile or non-volatile medium, and the separable or nonseparable medium implemented using an arbitrary method or technology for storing information such as a computer readable command, a data structure, a program module, or other data. The communication medium may generally include a computer readable command, a data structure, a program module, other data of a modulated data signal such as a carrier wave, or another transmission mechanism, and include an arbitrary information transmission medium.

The method and system of the present invention is described with reference to specific embodiments, but some or all of the components or the operations may be implemented using a computer system having a general-purpose hardware architecture.

According to an embodiment of the present invention described above, the network for transmitting high speed or low speed data can be automatically selected using the heterogeneous interfaces.

Further, a highly integrated subminiature server can be provided, and also, power consumption can be decreased.

The above-described embodiments of the present invention are merely examples, and it should be apparent to those skilled in the art that various modifications may be made to the above-described embodiments of the present invention without departing from the spirit or the scope of the invention. Accordingly, it should be understood that the embodiments of the present invention are not intended to limit the scope of the invention but to describe the invention in all aspects. For example, each component described in a singular form may be implemented in a distributed form, and similarly, components described in a distributed form may be implemented in a combined form.

The scope of the present invention should be defined by the appended claims rather than the detailed description described above, and all such changes or modifications derived from the scope of the appended claims and their equivalents should be interpreted as being included in the scope of the present invention.

What is claimed is:

1. A micro server based on a fabric network, comprising:
a plurality of computing modules;
a first switching module configured to connect the plurality of computing modules through a fabric network based on Ethernet;
a plurality of converters respectively connected to the plurality of computing modules; and
a second switching module connected to the plurality of converters through a fabric network based on peripheral component interface (PCI) express.

2. The micro server of claim 1, wherein each of the plurality of computing modules comprises a PCI express module, and
the PCI express module transceives data with a device, based on the PCI express.

3. The micro server of claim 2, wherein the plurality of computing modules transceive data with the device through a transmission protocol, and
the converter converts data between the PCI express module and the transmission protocol.

4. The micro server of claim 3, wherein the converter performs mapping between memory regions for transmitting data between the PCI express module and the transmission protocol.

5. The micro server of claim 4, wherein the converter converts a PCI express packet into a high speed protocol packet when transmitting data, and converts a high speed protocol packet into a PCI express packet when receiving data.

6. The micro server of claim 4, wherein the PCI express module performs mapping between a memory region of a central processing unit (CPU) and a memory region of the PCI express module.

7. The micro server of claim 1, wherein data transmission of the plurality of computing modules is performed using the first switching module through a network interface card.

8. The micro server of claim 7, wherein, when data is required to be transmitted at high speed, the data is transmitted to a PCI express module through a virtual network interface card.

9. The micro server of claim 8, wherein whether data is required to be transmitted at high speed is predesignated in a differentiated service field of an Internet protocol (IP) header packet, and
the data is transmitted through the PCI express module by determining the differentiated service field in a transmission control protocol (TCP)/IP stack.
